(19) United States
(12) Patent Application Publication
(10) Pub. No.: US 2025/0287982 A1
(43) Pub. Date: Sep. 18, 2025

(54) PROCESSING METHOD OF LACTIC ACID FERMENTED FOOD

(71) Applicant: CHINA AGRICULTURAL UNIVERSITY, Beijing (CN)

(72) Inventors: Liang ZHAO, Beijing (CN); Xiaojun LIAO, Beijing (CN); Dong YANG, Beijing (CN); Xiaolei ZHENG, Beijing (CN); Yuhan TANG, Beijing (CN); Sijia PENG, Beijing (CN); Zhuoqi ZHENG, Beijing (CN)

(21) Appl. No.: 19/075,760

(22) Filed: Mar. 10, 2025

(30) Foreign Application Priority Data
Mar. 14, 2024 (CN) 202410291861.3

(51) Int. Cl. A23L 29/00; A23B 2/10; A23L 23/00; C12R 1/225

(52) U.S. Cl. CPC A23L 29/065; A23B 2/103; A23L 23/00; A23V 2400/133; A23V 2400/169; C12R 2001/225

(57) ABSTRACT

The present disclosure discloses a processing method of lactic acid fermented food, including: performing a first mixing step by combining food raw materials with sodium chloride to create a first mixture; performing a second mixing treatment on the first mixture and a food acid to obtain a second mixture; performing a fermentation treatment on the second mixture using lactobacillus to obtain the lactic acid fermented food, wherein a content of the sodium chloride ranges from 5% to 7% by mass based on the mass of the food raw materials; a pH value of the second mixture is lower than or equal to 3.8; and the lactobacillus includes Lactobacillus plantarum and/or Lactobacillus curvatus. The method of the present disclosure has low initial salinity, low gas production and short fermentation period and is beneficial to large-scale production.

### CROSS-REFERENCE TO RELATED APPLICATION

This application claims priority to Chinese Patent Application No. 202410291861.3 filed on Mar. 14, 2024, the entire disclosure of which is incorporated herein by reference.

### TECHNICAL FIELD

The present disclosure relates to the field of food processing. More particularly, the present disclosure relates to a processing method of lactic acid fermented food, in particular to a processing method of chili sauce.

### BACKGROUND

Lactic acid fermented food is a food made by means of the fermentation of lactobacillus. Lactobacillus can convert sugar into lactic acid, thereby increasing the acidity of food and imparting a special flavor characteristic to the food. Many kinds of milk, vegetables, fruits, and meats can be fermented by lactobacillus to make various flavored foods or drinks, which are popular among consumers.

Lactic acid fermented food usually produces gas during the preparation process, and lactobacilli are widely present on the surface of food raw materials and in the outdoor environment. Therefore, this kind of food is usually prepared by natural fermentation in the outdoor environment, which takes a long fermentation time, and it is difficult to control the fermentation environment. In order to achieve the purpose of inhibiting the growth of contaminating microorganisms, people often add a large amount of edible salts to raw materials, but the resulting food has high salt content, which does not conform to consumer demand for low-salt diets.

Therefore, the current processing methods for lactic acid fermented food still need to be studied.

### SUMMARY

The present disclosure aims to solve at least one of the technical problems in the prior art at least to a certain extent. Therefore, the present disclosure provides a processing method of lactic acid fermented food. The method has low initial salinity, low gas production and short fermentation period and is beneficial to large-scale production. The fermented food prepared by this method is low in salt content and rich in lactobacillus content, and also has new flavor characteristics such as aroma, color, taste and texture with high overall acceptability, thereby achieving a high edible value.

It should be noted that the present disclosure is accomplished on the basis of the following efforts of the inventors.

Lactic acid fermented food (e.g., fermented chili or minced chilies) is mostly fermented naturally. This method relies on the spontaneous fermentation of naturally occurring lactobacilli on the food surface, which is susceptible to be contaminated by contaminating microorganisms and has high initial salinity, long fermentation time, and uncontrollable fermentation results, thereby seriously affecting the large-scale and standardized production of the lactic acid fermented food. Through research, the inventors have found that when the initial pH value of the fermentation system is controlled to be lower than or equal to 3.8 and the initial salt content is controlled to be within a range of 5% by mass to 7% by mass, the growth of Lactobacillus plantarum and/or Lactobacillus curvatus can be promoted, and the gas production can be inhibited. Therefore, the rapid growth of the Lactobacillus plantarum and/or the Lactobacillus curvatus can be achieved, and the growth of contaminating microorganisms can be inhibited. The further test results show that the fermentation system is stable, the fermentation period is short, and when expanded-production is performed in a sealed container, no gas swelling (sack expanding) occurs, which is conducive to large-scale production. The fermented food prepared by this method is low in salt content and rich in lactobacillus content, and also has new flavor characteristics in terms of aroma, color, taste and texture with high overall acceptability, thereby achieving a high edible value.

In this aspect, the present disclosure provides a method for processing lactic acid fermented food. According to an example of the present disclosure, the method includes: performing a first mixing step by combining food raw materials with sodium chloride to create a first mixture; performing a second mixing treatment on the first mixture and a food acid to obtain a second mixture; performing a fermentation treatment on the second mixture using lactobacillus to obtain the lactic acid fermented food, wherein a content of the sodium chloride ranges from 5% to 7% by mass based on the mass of the food raw materials; a pH value of the second mixture is lower than or equal to 3.8; and the lactobacillus includes Lactobacillus plantarum and/or Lactobacillus curvatus.

This method example provides low initial salinity, reduced gas production, a short fermentation period, and supports large-scale production. The fermented food prepared by this method is low in salt content and rich in lactobacillus content, and also has new flavor characteristics such as aroma, color, taste and texture with high overall acceptability, thereby achieving a high edible value.

It should be noted that, for example, a nylon polyethylene bag may be conveniently selected as the closed container, and sealed by means of a sealing treatment.

According to the example of the present disclosure, the sodium chloride ranges from 5.5% by mass to 6.5% by mass based on the mass of the food raw materials; and an addition amount of the food acid ranges from 0.2% by mass to 0.5% by mass based on a mass of the first mixture.

Through a large number of tests, the inventors obtain the above-mentioned optimal addition amounts of the sodium chloride and the food acid, thereby, further reducing the gas production; reducing the addition amount of the sodium chloride, avoiding a white biofilm produced in the fermentation process of food, thereby enhancing the food safety and improving the color of the food.

According to the example of the present disclosure, the food raw materials are crushed prior to performing the first mixing treatment. Therefore, the food raw materials are fully mixed with the sodium chloride, which is conducive to subsequent fermentation treatment.

It should be noted that the crushing treatment may involve chopping, mincing or smashing with an external force. The specific implementation method for crushing the food raw materials is not strictly limited herein.

According to the example of the present disclosure, the lactic acid fermented food includes at least one of chili sauce, preserved vegetables, pickled vegetables, pickled mustard greens, dried vegetables, and pickled cucumbers; and the food acid includes options such as acetic acid, benzoic acid, N-butyric acid, citric acid, formic acid, fumaric acid, lactic acid, malic acid, propionic acid, succinic acid, glutamic acid, carbonic acid, and phosphoric acid. According to the method of the present disclosure, vegetables may be fermented by the Lactobacillus plantarum and the Lactobacillus curvatus to prepare a lactic acid fermented food having a new flavor, thereby improving an edible value of food.

According to the example of the present disclosure, the lactobacillus includes Lactobacillus plantarum preserved under deposit number of CGMCC No. 14398 and/or Lactobacillus curvatus preserved under deposit number of CGMCC No. 14397. Therefore, the lactic acid fermented food is further imparted with unique aroma, color, taste and texture.

According to the example of the present disclosure, a suspension of the lactobacillus is inoculated into the second mixture for fermentation, wherein the initial inoculation concentration of lactobacilli is greater than or equal to 4 lg CFU/mL, and a concentration of the lactobacillus during fermentation is greater than or equal to 7 lg CFU/mL. Therefore, increasing the number of the lactobacillus can help it become the dominant microorganism in the fermentation system, shortening the fermentation time.

According to the example of the present disclosure, a high-pressure treatment (100-600 MPa for 1-60 min) is applied to the second mixture before fermentation. Therefore, reducing the number of non-lactobacillus is conducive to the rapid growth of lactobacillus as the dominant microorganism in the fermentation system, shortening the fermentation time.

It should be noted that if the lactobacilli are high-pressure resistant, they can be inoculated before high-pressure treatment; otherwise, inoculated after treatment; and in the case that the lactobacillus is not resistant to high pressure, the lactobacillus can be inoculated after the second mixture is subjected to the high-pressure treatment.

According to the example of the present disclosure, prior to performing the fermentation treatment, the lactobacillus is inoculated into the second mixture and then subjected to a high-pressure treatment at a pressure of 100 MPa to 600 MPa for 1 min to 60 min. Therefore, the number of non-lactobacillus is further reduced, and the fermentation time is shortened. According to the example of the present disclosure, the high-pressure treatment is performed at a pressure of 250 MPa to 450 MPa for 5 min to 20 min. Therefore, it is beneficial to retain the original nutrients of the food raw materials, and obtain new aromas, colors, tastes and textures.

According to the example of the present disclosure, the fermentation treatment is conducted in a light-protected, closed container for a duration of 10 to 20 days, resulting in lactic acid fermented food with unique aroma, color, taste, and texture.

In another aspect, this disclosure provides a method for processing chili sauce. According to an example of the present disclosure, the method includes: performing a first mixing step by combining crushed chili raw materials with 6% sodium chloride by mass to obtain a first mixture; performing a second mixing treatment on the first mixture and citric acid to obtain a second mixture, wherein an addition amount of the citric acid ranges from 0.25% by mass to 0.35% by mass based on the mass of the first mixture; and performing a fermentation treatment on the second mixture using lactobacillus to obtain the chili sauce, wherein the lactobacillus is Lactobacillus plantarum preserved under deposit number of CGMCC No. 14398, a final inoculation concentration of the lactobacillus is greater than or equal to 4 lg CFU/mL, and a concentration of the lactobacillus during fermentation is greater than or equal to 7 lg CFU/mL; prior to performing the fermentation, the method further includes a high-pressure treatment at 350 MPa for 10 min; the fermentation treatment is performed in a closed container and protected from light; and the duration of the fermentation treatment ranges from 10 to 14 days.

This method effectively reduces gas production during chili sauce preparation, allowing fermentation in a closed container, the fermentation environment is controllable, and the food safety is guaranteed. The prepared chili sauce is low in salt content, high in number of the lactobacillus and rich in lactobacillus content, and also has flavor characteristics such as new aroma, color, taste and texture with high overall acceptability. Therefore, the method of the present disclosure improves the edible value of the chili sauce.

Additional aspects and advantages will become apparent from the following description and through practical application.

### BRIEF DESCRIPTION OF DRAWINGS

The above and/or additional aspects and advantages will be apparent form the description of the embodiments and the accompanying drawings, in which:

FIG. 1 shows changes in the total number of colonies in low-salt chili sauce during fermentation according to Example 1 of the present disclosure;

FIG. 2 shows changes in the total number of lactobacillus in the low-salt chili sauce during fermentation according to Example 1 of the present disclosure;

FIG. 3 shows changes in the number of mold and yeast in the low-salt chili sauce during fermentation according to Example 1 of the present disclosure;

FIG. 4 shows changes in the pH value of the low-salt chili sauce during fermentation according to Example 1 of the present disclosure;

FIG. 5 shows changes in the total acid value of the low-salt chili sauce during fermentation according to Example 1 of the present disclosure;

FIG. 6 shows changes in the percent of chloride content in the low-salt chili sauce during fermentation according to Example 1 of the present disclosure;

FIG. 7 shows changes in the percent of amino acid nitrogen content in the low-salt chili sauce during fermentation according to Example 1 of the present disclosure;

FIG. 8 shows changes in the content of nitrites in the low-salt chili sauce during fermentation according to Example 1 of the present disclosure;

FIG. 9 shows changes in sensory indicators of chili sauce in a 6% edible salt group at different fermentation times according to Example 1 of the present disclosure, in which: 6/3 represents Day 3 of fermentation of the chili sauce in the 6% edible salt group; 6/5 represents Day 5 of fermentation of the chili sauce in the 6% edible salt group; 6/7 represents Day 7 of fermentation of the chili sauce in the 6% edible salt group; 6/11 represents Day 11 of fermentation of the chili sauce in the 6% edible salt group; 6/14 represents Day 14 of fermentation of the chili sauce in the 6% edible salt group;

FIG. 10 shows changes in sensory indicators of chili sauce in an 8% edible salt group at different fermentation times according to Example 1 of the present disclosure, in which: 8/3 represents Day 3 of fermentation of the chili sauce in the 8% edible salt group; 8/5 represents Day 5 of fermentation of the chili sauce in the 8% edible salt group; 8/7 represents Day 7 of fermentation of the chili sauce in the 8% edible salt group;

FIG. 11 shows changes in sensory indicators of chili sauce in a 10% edible salt group at different fermentation times according to Example 1 of the present disclosure, in which: 10/3 represents Day 3 of fermentation of the chili sauce in the 10% edible salt group; 10/5 represents Day 5 of fermentation of the chili sauce in the 10% edible salt group; 10/7 represents Day 7 of fermentation of the chili sauce in the 10% edible salt group;

FIG. 12 shows changes in the total number of lactobacillus of chopped chili of an inoculated fermentation type over time at 6% salt content according to Example 2 of the present disclosure;

FIGS. 13a to 13c are investigation result diagrams showing the total number of colonies (FIG. 13a), the total number of lactobacillus (FIG. 13b), and the total number of yeast and mold (FIG. 13c) of chili sauce during fermentation according to Comparative example 1 of the present disclosure; and

FIG. 14 is a result diagram of composition analysis of communities on genus level of the chili sauce during fermentation according to Comparative example 1 of the present disclosure, wherein EJT represents the variety of Erjintiao chili, DJOd represents Day 0 of fermentation of minced chilies, and the monitoring lasted for 0, 7, 14, 21, 28, 38, 48 days.

### DESCRIPTION OF EMBODIMENTS

The following examples illustrate this disclosure and are provided for explanatory purposes only, not as limitations.

The terms ‘first’ and ‘second’ are descriptive only and do not imply relative importance or quantity of features. Thus, the features defined by the terms “first” and “second” may include one or more of the features either explicitly or implicitly. Further, in the description of the present disclosure, unless otherwise stated, the term “a plurality of” means two or more.

The endpoints of a range and any value disclosed herein are not limited to such precise range or value, and these ranges or values should be understood to contain values that are close to these ranges or values. For the numeric ranges, one or more new numeric ranges may be obtained by combining the endpoint values of each range, the endpoint values of each range and individual point values, and individual point values, and these numeric ranges shall be deemed to be specifically disclosed herein.

The term “comprising” or “including” herein is an open-ended expression, that is, including the content indicated in the present disclosure, but not excluding other aspects.

The term “optionally”, “optional” or “option” herein means that the subsequent event or situation may but may not necessarily occur, and this description includes a situation in which the event or situation occurs, and the situation in which the event or condition does not occur.

As used herein, the term “lactobacillus” refers to bacteria that can ferment carbohydrates and produce a large amount of lactic acid, which is one of the most common and important beneficial bacteria in food production. “Lactobacillus plantarum” or “Lactobacillus curvatus” is one of lactobacilli.

As used herein, the term “gas swelling” is equivalent to “sack expanding”, which refers to a phenomenon of pressure increase in a closed container caused by gas production due to microbial metabolism when lactic acid fermented food is prepared by fermentation in the closed container. Exemplarily, the phenomenon of sack expanding can be observed when a sealed nylon polyethylene bag is used for fermentation.

As used herein, the term “total acid” refers to the acids present in fermented food. The content of the total acid affects the safety and flavor quality of lactic acid fermented food. If the content of total acid is too low, the fermentation time is not long enough, the expected flavor quality cannot be achieved; and if the content of total acid is too high, the food will be spoiled, which will affect the safety.

As used herein, the term “amino acid nitrogen” refers to the amino acid nitrogen found in fermented food. The content of the amino acid nitrogen affects the flavor characteristic of lactic acid fermented food.

The following examples illustrate the solutions provided here and are not intended to limit the scope of this disclosure. Where specific techniques or conditions are not described in the examples, they are performed according to techniques or conditions described in the literature in the art or according to the product description. The reagents or instruments used without specifying manufacturers are all conventional products which are commercially available.

### EXAMPLE 1

In this example, low-salt chili sauce was produced according to the following

steps:
1. fresh, non-rotten and non-moldy chili raw materials (Erjingtiao red chili) were selected;
2. chili raw materials sterilization: the chili raw materials were washed with clear water; the clean chili raw materials were put into the sodium hypochlorite solution (200 mg/L) according to a material-liquid mass ratio of 1:8, and subjected to an ultrasonic treatment at room temperature for 25 min and the ultrasonic intensity was 40 Hz (500 W); the chili raw materials were taken out and drained off, and rinsed with distilled water;
3. mincing, mixing with salt and adjusting acid: the chilies rinsed with the distilled water were minced and divided into 3 groups, and each group was added with 6%, 8%, and 10% of edible salt according to a mass ratio, respectively, stirred well, then added with 0.25% citric acid, and mixed well;
4. inoculation and encapsulation: a suspension (108 CFU/mL) of high-pressure resistant Lactobacillus plantarum CGMCC No. 14398 (a lactobacillus plantarum which is known in the prior art, and is currently preserved in the China General Microbiological Culture Collection Center, with the preservation number of CGMCC No. 14398, from the laboratory where the inventor works) was inoculated according to an inoculation amount of 8% (mass ratio), and put into a nylon polyethylene bag, which was then sealed;
5. secondary sterilization: the minced chilies sealed in the nylon polyethylene bag were subjected to a high-pressure treatment at 350 MPa for 10 min; and
6. fermentation: the fermentation was performed at 30° C. indoors protected from light for 14 days to obtain the low-salt chili sauce.

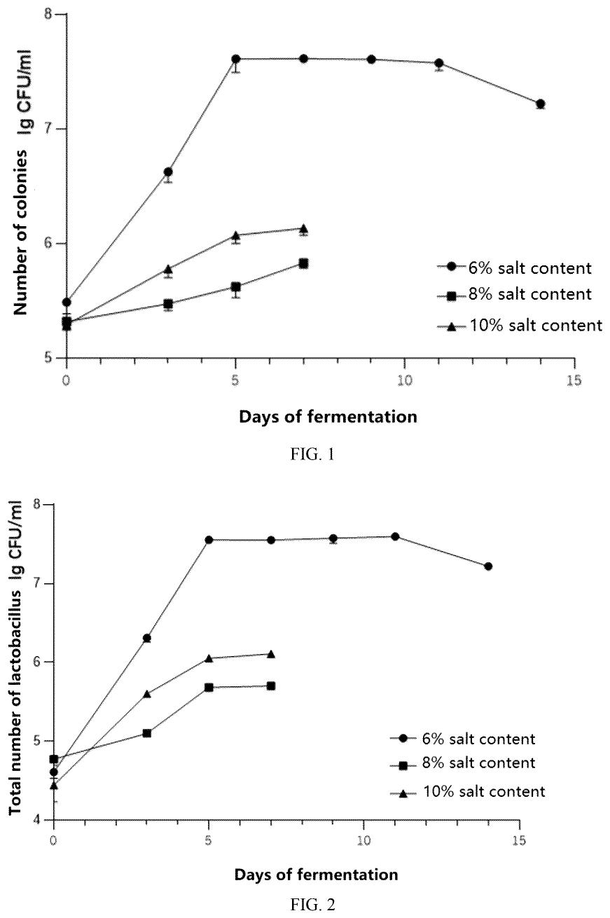

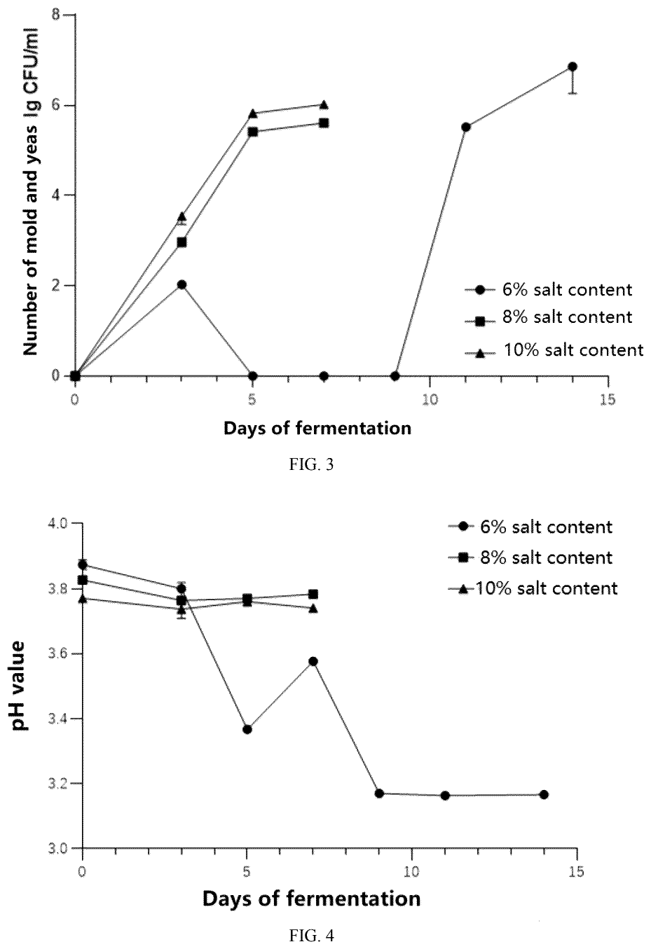

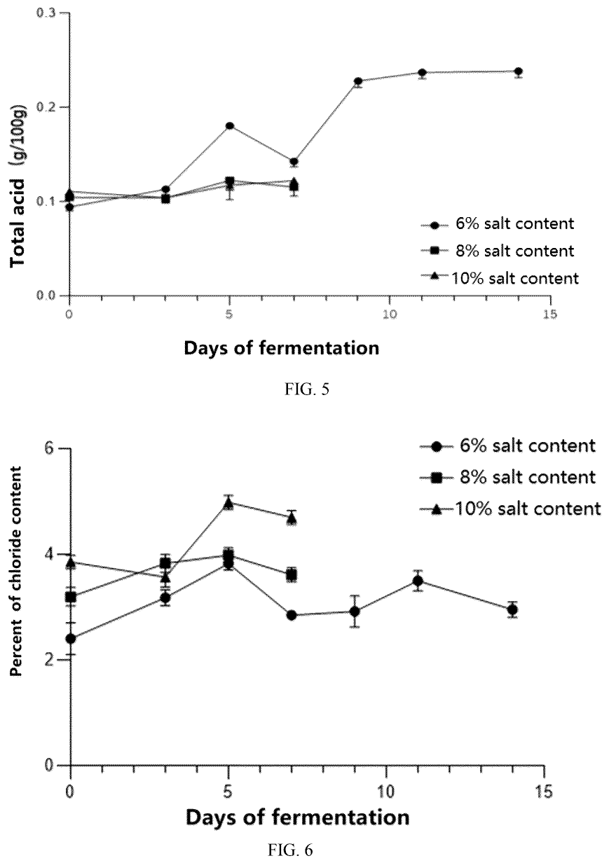

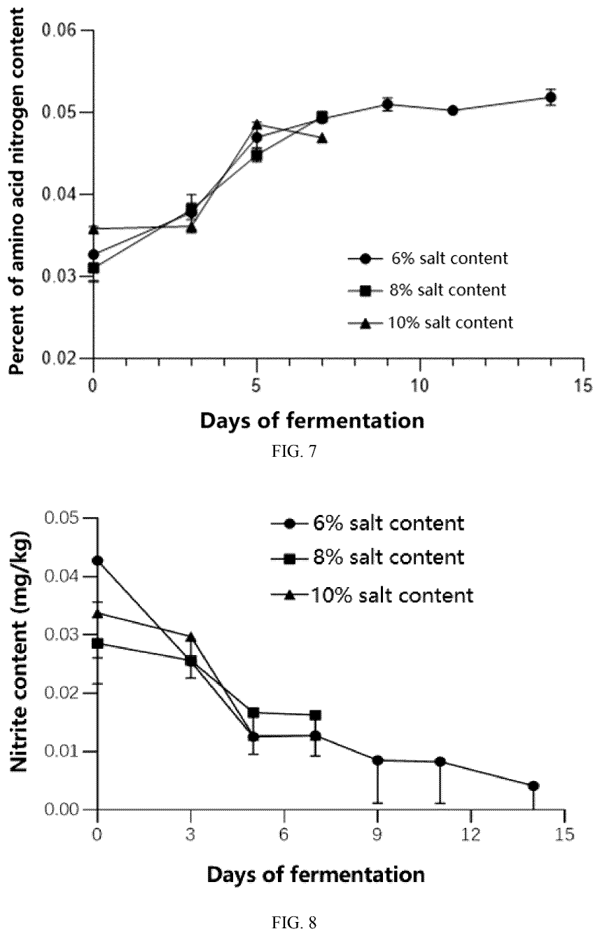

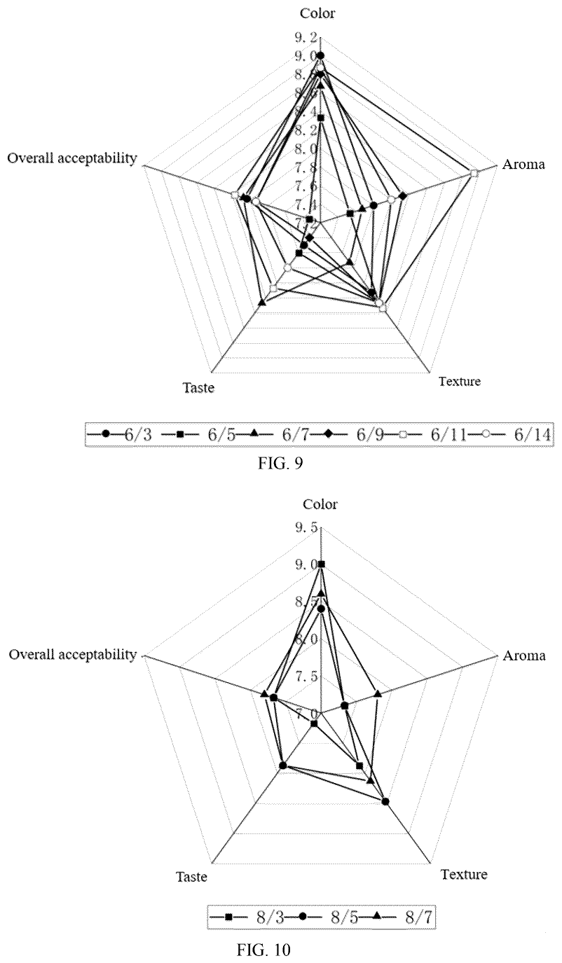

Monitoring of key indicators: the changes in the total number of colonies (FIG. 1), the total number of lactobacillus (FIG. 2), the number of mold and yeast (FIG. 3), the pH value of fermentation products (FIG. 4), the total acid content (FIG. 5), the chloride content (FIG. 6), the amino acid nitrogen content (FIG. 7), the nitrite content (8) and sensory indicators (FIG. 9 to FIG. 11) were detected during fermentation.

The results were shown as follows.

(1) During fermentation, the total number of colonies in chili sauce in 6% edible salt group was the largest (FIG. 1), exceeding 7 lg CFU/mL; and in particular, the total number of lactobacillus was high (FIG. 2), exceeding 7 lg CFU/mL. Therefore, the chili sauce prepared in the 6% edible salt group was rich in lactobacillus and had high nutritional value.

(2) In the 6% edible salt group, the number of mold and yeast decreased first and then was increased abruptly (FIG. 3). After analysis, it was considered that the decrease of the number in the early stage of fermentation was caused by the growth of lactobacillus as dominant bacteria, and the abrupt increase of the number in the late stage of fermentation was caused by the massive growth of the yeast. In the later stage of fermentation, the whole fermentation system was in an anaerobic environment, the growth of mold was inhibited, and meanwhile the peak growth of the lactobacillus had passed, so the yeast grew rapidly and proliferated in large quantities by using the lactic acid in the fermentation system. Therefore, compared with high-salt groups (an 8% edible salt group and a 10% edible salt group), yeast and lactobacillus were fermented synergetically, offering new flavor quality to the chili sauce (FIG. 9 to FIG. 11).

(3) In the late stage of fermentation, the total acid content in the chili sauce in the 6% edible salt group tended to be stable (FIG. 5), achieving fixed food flavor and long shelf life.

(4) With the extension of fermentation time, the nitrite content in the chili sauce in the 6% edible salt group continued to decrease, and the food safety was improved (FIG. 8).

(5) With the extension of fermentation time, the amino acid nitrogen content in the chili sauce in the 6% edible salt group increased, offering the unique flavor quality to the chili sauce (FIG. 7).

(6) Throughout fermentation, the 6% salt group maintained the lowest chloride levels, resulting in chili sauce with low salt content and high edible value.

### EXAMPLE 2

In this example, a low-salt chili sauce was produced according to the following steps:
1. fresh, non-rotten and non-moldy chili raw materials (Erjingtiao red chili) were selected;
2. chili raw materials sterilization: the chili raw materials were washed with clear water; the clean chili raw materials were put into the sodium hypochlorite solution (200 mg/L) according to a material-liquid mass ratio of 1:8, and subjected to an ultrasonic treatment at room temperature for 25 min and the ultrasonic intensity was 40 Hz (500 W); the chili raw materials were taken out and drained off, and rinsed with distilled water;
3. mincing, mixing with salt and adjusting acid: the chilies rinsed with the distilled water were minced, and each group was added with 6% of edible salt according to a mass ratio respectively, stirred well, then added with 0.35% citric acid, and mixed well;
4. inoculation and encapsulation: a suspension (108 CFU/mL) of high-pressure resistant Lactobacillus plantarum CGMCC No. 14398 (preserved in the China General Microbiological Culture Collection Center, with the preservation number of CGMCC No. 14398) was inoculated according to an inoculation amount of 8% (mass ratio), and put into a nylon polyethylene bag, which was then sealed;
5. secondary sterilization: the minced chilies sealed in the nylon polyethylene bag were subjected to a high-pressure treatment at 350 MPa for 10 min; and
6. fermentation: the fermentation was performed at 30° C. indoors protected from light for 14 days to obtain the low-salt chili sauce.

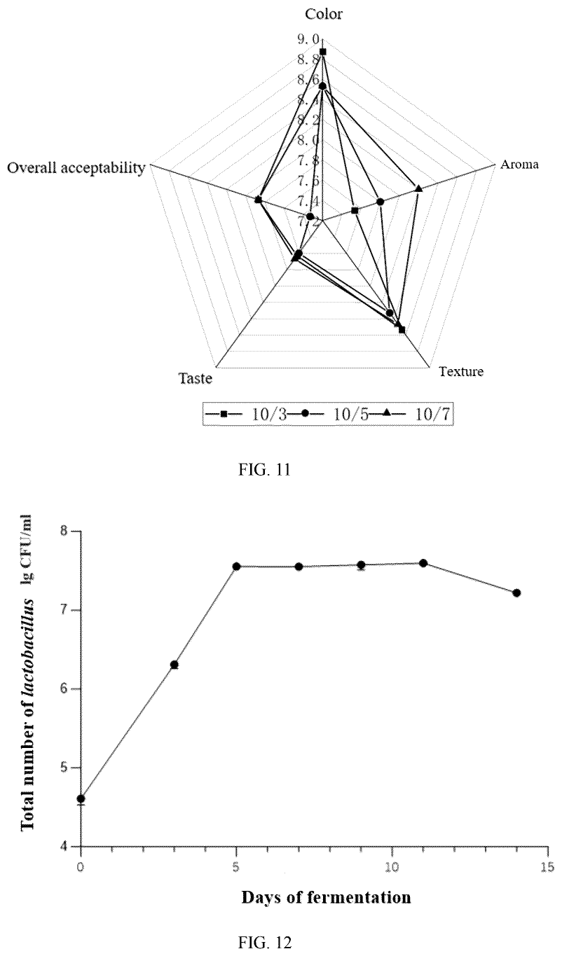

Further, the inventors especially investigated the changes in the total number of lactobacillus in the chili sauce during fermentation (FIG. 12).

The results showed that when the minced chilies inoculated with Lactobacillus plantarum CGMCC No.14398 began to ferment, the total number of lactobacillus in the system reached about 4.5 lg CFU/ml; and from Day 0 to Day 5 of fermentation, the total number of lactobacillus increased continuously with the progress of fermentation, and then remained constant after 5 days, and the total number of lactobacillus was maintained at 7.219 lg CFU/ml or above.

The above results showed that under the processing conditions of this example, the total number of lactobacillus in the whole fermentation process was at a high level, and they were dominant microorganisms in the fermentation system. Therefore, the fermentation period was significantly shortened, and the probiotic content in the chili sauce was rich.

### EXAMPLE 3

In this example, the chili sauce was prepared by referring to the method of Example 2. Compared with Example 2, the difference was that in step 4, a high-pressure resistant Lactobacillus curvatus CGMCC No. 14397 was inoculated.

The results showed that when the minced chilies inoculated with Lactobacillus curvatus CGMCC No.14397 began to ferment, the total number of lactobacillus in the system reached about 4.5 lg CFU/ml; and from Day 0 to Day 5 of fermentation, the number of lactobacillus increased continuously with the progress of fermentation, and then remained constant after 5 days, and the number of lactobacillus was maintained at 7 lg CFU/ml or above. Under the processing conditions of this example, the number of lactobacillus in the whole fermentation process was at a high level, and they were dominant microorganisms in the fermentation system. Therefore, the fermentation period was significantly shortened, and the probiotic content in the chili sauce was rich.

### Comparative Example 1

In this comparative example, the chili sauce was prepared by referring to the method of Example 2. Compared with Example 2, the difference was that: (1) in step 3, the addition amount of edible salt was 10%, and the addition amount of citric acid was 0.16%; and (2) in step 4, a white polyethylene (PET) bag was used for fermentation, and an air vent was reserved to avoid gas swelling.

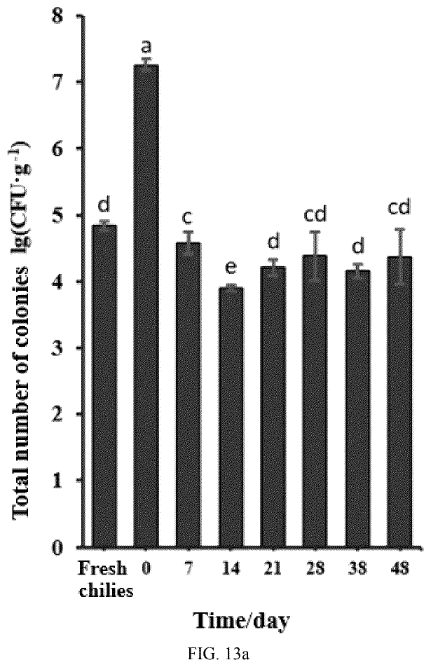

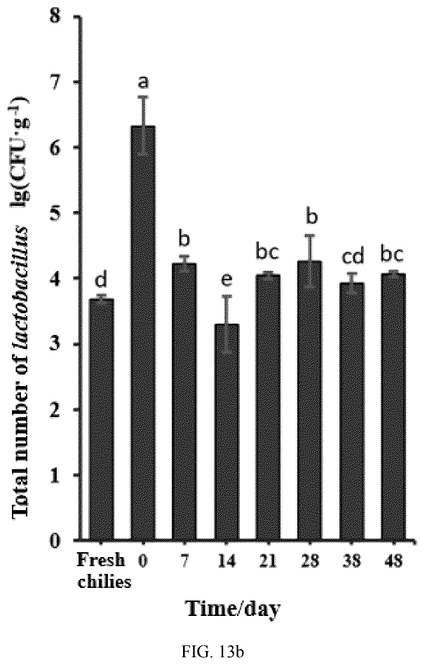

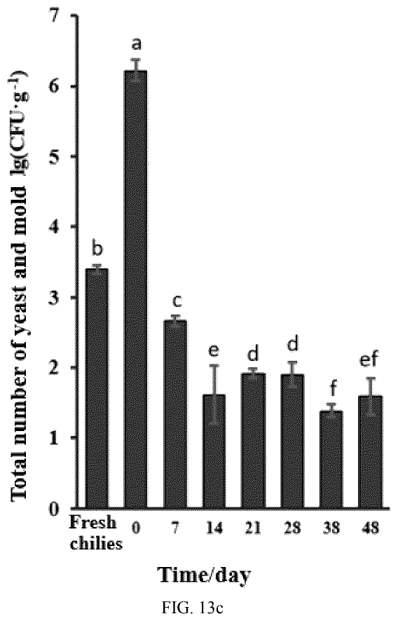

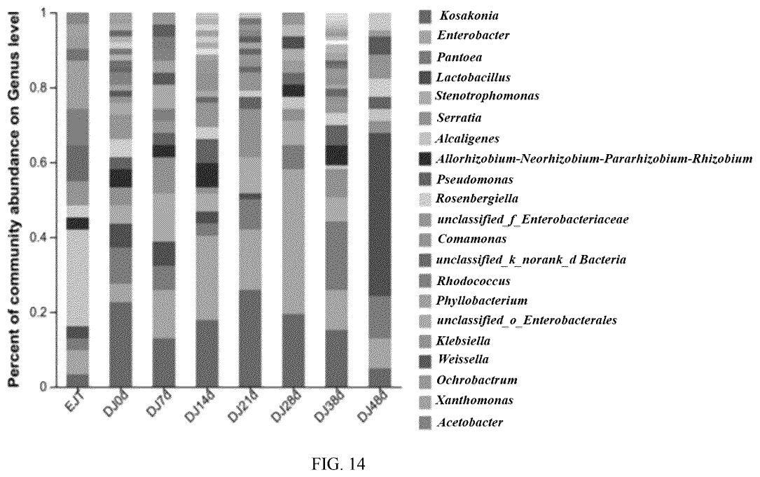

The key indicators were monitored: during fermentation, the total number of colonies, the total number of lactobacillus, the total number of yeast and mold (FIGS. 13a to 13c), and the composition of bacterial communities at the level of genus (FIG. 14) were detected.

The results were shown as follows.

(1) During fermentation, the total number of colonies in the chili sauce was maintained at around 5 lg CFU/g (FIG. 13a), and the total number of lactobacillus was maintained at around 4 lg CFU/g (FIG. 13b); and the composition of colonies in the chili sauce at the level of genus was complex (FIG. 14). Therefore, compared with the 6% edible salt group in Example 1 and Examples 2-3, the lactobacillus in the obtained chili sauce was low in abundance and had limited in nutritional value.

(2) During fermentation, the total number of yeast and mold was basically maintained at around 2 lg CFU/g (FIG. 13c). The analysis showed that there was no significant change in the proportion of mold and yeast species, and the yeast and the lactobacillus did not play any synergistic fermentation role, and the obtained chili sauce had a single flavor.

(3) By Day 48 of fermentation, lactobacillus in minced chilies reached about 4 lg CFU/mL, becoming the dominant microorganism in the fermentation system (the abundance was 43.55%), and the minced chilies entered a lactic acid fermentation stage. Compared with the 6% edible salt group in Example 1 and Examples 2-3, the method of this comparative example had long fermentation period, and low probiotic content in chili sauce product.

### Comparative Example 2

In this comparative example, the chili sauce was prepared by referring to the method of Example 2. Compared with Example 2, the difference was that: in step 3, the addition amount of edible salt was 10%, and the addition amount of citric acid was 0.35%.

### Comparative Example 3

In this comparative example, the chili sauce was prepared by referring to the method of Example 2. Compared with Example 2, the difference was that: in step 3, the addition amount of edible salt was 10%, and the addition amount of citric acid was 0.16%.

### Comparative Example 4

In this comparative example, the chili sauce was prepared by referring to the method of Example 2. Compared with Example 2, the difference was that: in step 3, the addition amount of edible salt was 6%, and the addition amount of citric acid was 0.16%.

### Result Analysis

The inventors mass-produced fermented chili sauce products by referring to the methods of Examples 1-3 and the methods of Comparative examples 1-4, and investigated whether and when the gas swelling occurred in the fermentation process. The results were shown in Table 1.

The results showed that, when a well-sealed fermentation container was used for indoor fermentation protected from light, the addition amount of edible salt and the initial pH of fermentation had significant impacts on the gas production rate in the fermentation process. (1) When the addition amount of sodium chloride was controlled in the range of 5% to 7% by mass, the pH of the chili raw materials to be fermented was adjusted to below 3.8 before fermentation, the gas production of Lactobacillus plantarum and Lactobacillus curvatus could be effectively inhibited. (2) When a final inoculation concentration of the lactobacillus was greater than or equal to 4 lg CFU/mL and a concentration of the lactobacillus during fermentation was greater than or equal to 7 lg CFU/mL, gas swelling was not observed during monitoring period, and the fermentation period was short.

The above results showed that the 6% edible salt group in Example 1 and the methods of Examples 2-3 could effectively reduce the gas production of the lactic acid fermented food in the preparation process, among which the 6% edible salt group in Example 1 had an optimal effect.

TABLE 1
Monitoring of gas swelling after expanded production by the
methods of Examples 1-3 and Comparative examples 1-4

| | Initial | Whether gas | | |
|---|---|---|---|---|
| | pH of | swelling occurred | Gas | |
| | fer- | during | welling | Monitoring |
| Test groups | mentation | fermentation | time | endpoint |
| Example 1 | 3.8 | No | / | Day 14 |
| 6% edible salt group | | | | |
| Example 1 | 3.8 | Yes | Day 7 | Day 7 |
| 8% edible salt group | | | | |
| Example 1 | 3.8 | Yes | Day 7 | Day 7 |
| 10% edible salt group | | | | |
| Example 2 | 3.5 | No | / | Day 14 |
| Example 3 | 3.5 | No | / | Day 48 |
| Comparative Example 1 | 4.0 | /(Natural open | / | Day 48 |
| | | fermentation) | | |
| Comparative example 2 | 3.5 | Yes | Day 7 | Day 7 |
| Comparative example 3 | 4.0 | Yes | Day 7 | Day 7 |
| Comparative example 4 | 4.0 | Yes | Day 7 | Day 7 |

Further, the inventors investigated the key quality indicators such as total acid, nitrite content, amino acid nitrogen, chloride content, and effective acidity of chili sauce products mass-produced by the methods of Example 1 and Comparative example 1 (a common preparation process of fermented chili sauce), and the results were shown in Table 2.

The results showed that the chili sauce product prepared in Example 1: (1) had the lowest total acid content, nitrite content and chloride content, as well as good food safety; (2) the effective acidity was as low as 3.17 and the amino acid nitrogen content was low, so the fermented chili product was imparted with new flavor qualities such as aroma, color, taste, and texture, and the overall acceptability of the chili sauce product was improved.

TABLE 2
Investigation results of key quality indicators of chili sauce products
prepared by Example 1 and Comparative example 1

| | | | Amino | | pH of |
|---|---|---|---|---|---|
| | Total | | acid | | fer- |
| | acid | Nitrite | nitrogen | Chloride | mentation |
| Test groups | (g/100 g) | (mg/kg) | (g/100 g) | (g/100 g) | endpoint |
| Example 1 | 0.239 | 0.0042 | 0.0529 | 2.959 | 3.17 |
| 6% edible salt group | | | | | |
| Example 1 | 0.116 | 0.0163 | 0.0500 | 3.591 | 3.78 |
| 8% edible salt group | | | | | |
| Example 1 | 0.122 | 0.0128 | 0.047 | 4.704 | 3.74 |
| 10% edible salt group | | | | | |
| Comparative | 0.541 | ≤4 mg/kg | 0.322 | 8.205 | 3.5 |
| example 1 | | | | | |

Wherein, the effective acidity was the pH of the fermented chili sauce product, reflecting the taste quality of the product.

Although the examples of the present disclosure have been shown and described above, it can be understood that the above examples are exemplary and should not be construed as limiting the present disclosure, and those skilled in the art can make changes, modifications, substitutions and variations to the above-mentioned examples within the scope of the present disclosure.

What is claimed is:

1. A processing method of lactic acid fermented food, the method comprising:
performing a first mixing step by combining food raw materials with sodium chloride to create a first mixture;
performing a second mixing treatment on the first mixture and a food acid to obtain a second mixture; and
performing a fermentation treatment on the second mixture using lactobacillus to obtain the lactic acid fermented food, wherein
a content of the sodium chloride ranges from 5% by mass to 7% by mass, based on a mass of the food raw materials;
a pH of the second mixture is lower than or equal to 3.8; and
the lactobacillus comprises Lactobacillus plantarum and/or Lactobacillus curvatus.

2. The method according to claim 1, wherein the addition amount of the sodium chloride ranges from 5.5% by mass to 6.5% by mass based on the mass of the food raw materials; and
an addition amount of the food acid ranges from 0.2% by mass to 0.5% by mass based on a mass of the first mixture.

3. The method according to claim 1, wherein the food raw materials are crushed prior to said performing the first mixing treatment.

4. The method according to claim 1, wherein:
the lactic acid fermented food comprises at least one of chili sauce, preserved vegetables, pickled vegetables, pickled mustard greens, dried vegetables, and pickled cucumbers; and
the food acid is selected from at least one of acetic acid, benzoic acid, N-butyric acid, citric acid, formic acid, fumaric acid, lactic acid, malic acid, propionic acid, succinic acid, glutamic acid, carbonic acid, and phosphoric acid.

5. The method according to claim 1, wherein the lactobacillus comprises Lactobacillus plantarum preserved under deposit number of CGMCC No. 14398 and/or Lactobacillus curvatus preserved under deposit number of CGMCC No. 14397.

6. The method according to claim 1, wherein the fermentation treatment comprises:
inoculating a suspension of the lactobacillus into the second mixture for fermentation, wherein:
an initial inoculation concentration of the lactobacillus is greater than or equal to 4 lg CFU/mL, and a concentration of the lactobacillus during the fermentation treatment is greater than or equal to 7 lg CFU/mL.

7. The method according to claim 1, wherein the second mixture is subjected to a high-pressure treatment prior to said performing the fermentation treatment, wherein:
a pressure of the high-pressure treatment ranges from 100 MPa to 600 MPa; and
a duration of the high-pressure treatment ranges from 1 min to 60 min.

8. The method according to claim 7, wherein:
the pressure of the high-pressure treatment ranges from 250 MPa to 450 MPa; and
the duration of the high-pressure treatment ranges from 5 min to 20 min.

9. The method according to claim 1, wherein:
the fermentation treatment is performed in a closed container and protected from light; and
a duration of the fermentation treatment ranges from 10 days to 20 days.

10. A processing method of chili sauce, the method comprising:
performing a first mixing step by combining crushed chili raw materials with 6% sodium chloride by mass to obtain a first mixture;
performing a second mixing treatment on the first mixture and citric acid to obtain a second mixture, wherein an addition amount of the citric acid ranges from 0.25% by mass to 0.35% by mass based on a mass of the first mixing material; and
performing a fermentation treatment on the second mixture using lactobacillus to obtain the chili sauce, wherein the lactobacillus is Lactobacillus plantarum preserved under deposit number of CGMCC No. 14398, wherein a final inoculation concentration of the lactobacillus is greater than or equal to 4 lg CFU/mL, and wherein a concentration of the lactobacillus during the fermentation treatment is greater than or equal to 7 lg CFU/mL, wherein the fermentation treatment is performed in a closed container and protected from light, and wherein a duration of the fermentation treatment ranges from 10 days to14 days,
wherein the method further comprising a high-pressure treatment at 350 MPa for 10 min prior to fermentation.
